(19) United States
(12) Patent Application Publication
(10) Pub. No.: US 2004/0102586 A1
(43) Pub. Date: May 27, 2004

(54) Resins comprised of alkyl phenols and of glyoxylic acid derivatives, and their use as demulsifiers

(76) Inventors: Dirk Leinweber, Burghausen (DE); Elisabeth Wasmund, Burgkirchen (DE)

Correspondence Address: CLARIANT CORPORATION, INTELLECTUAL PROPERTY DEPARTMENT, 4000 MONROE ROAD, CHARLOTTE, NC, 28205, US

(21) Appl. No.: 10/432,147

(22) PCT Filed: Nov. 2, 2001
(86) PCT No.: PCT/EP01/12670

(30) Foreign Application Priority Data
Nov. 17, 2000 (DE) 10057044.5

(51) Int. Cl. C08F 283/00

(52) U.S. Cl. 525/534

(57) ABSTRACT

The invention relates to the use of resins that can be obtained from compounds of formula (1), in which substituents R¹ and OH can, with regard to one another, be located in ortho position, meta position or para position, and R¹ represents C₁-C₃₀ alkyl, C₂-C₃₀ alkenyl, C₆-C₁₈ aryl or C₇-C₃₀ alkyl aryl. The inventive resins are produced using the following steps, which can be carried out in any order: A) reacting with a compound of formula (2): OHC—COOR², wherein R² represents H, C₁-C₃₀ alkyl, C₂-C₃₀ aryl or C₇-C₃₀ alkyl aryl, and; B) alkoxylating with a C₂-C₄ alkylene oxide in molar excess so that the resulting alkoxylate has a degree of alkoxylation of 0 to 100 alkylene oxide units per OH group. In addition, the inventive resins have a molecular weight ranging from 250 to 100,000 units in quantities of 0.0001 to 5 wt. % with regard to the emulsion. The inventive resins are used a demulsiflers for oil-in-water emulsions, in particular, in the domain of petroleum extraction.

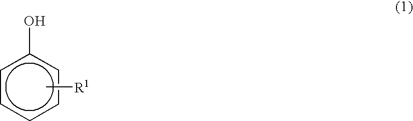

The present invention relates to the use of resins preparable by condensation of alkylphenols with glyoxylic acid derivatives for breaking water-oil emulsions, in particular in the production of crude oil.

During its recovery, crude oil is produced as an emulsion with water. Before the crude oil is further processed, these crude oil emulsions must be broken into the oil and water constituents. For this purpose, use is generally made of petroleum breakers. Petroleum breakers are surface-active compounds which are able to effect the required separation of the emulsion constituents within a short time.

The petroleum breakers used are, inter alia, alkylphenol aldehyde resins, which are disclosed, for example, in U.S. Pat. No. 4,032,514. These resins are obtainable from the condensation of a p-alkylphenol with an aldehyde, in most cases formaldehyde. The resins are often used in alkoxylated form, as is disclosed, for example, in DE-A-24 45 873. For this, the free phenolic OH groups are reacted with an alkylene oxide.

The condensation of alkylphenols with glyoxylic acid has been described, for example, in U.S. Pat. No. 3,954,808. The products obtained were neither alkoxylated on the phenolic OH group, nor used as petroleum breakers.

U.S. Pat. No. 2,499,370 discloses alkylphenol glyoxal resins which are suitable as breakers for oil/water emulsions.

The varying properties (e.g. asphaltene and paraffin content) and proportions of water in different crude oils make it imperative to further develop the existing petroleum demulsifiers. In particular, a low dosing rate of the demulsifier to be used as well as the higher effectiveness which is to be strived for is most important from an economic and ecological point of view.

The object was thus to develop novel petroleum breakers which are superior in their effect to the alkylphenol aldehyde resins already known, and can be used in an even lower concentration.

Surprisingly, it has been found that resins based on alkylphenol glyoxylic acid derivative condensates exhibit an excellent effect as petroleum breakers even at a very low concentration.

The invention therefore provides for the use of resins obtainable from compounds of the formula (1)

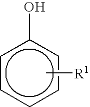

in which the substituents R¹ and OH may be in ortho, meta or para position relative to one another, and R¹ is C₁-C₃₀-alkyl, C₂-C₃₀-alkenyl, C₆-C₁₈-aryl or C₇-C₃₀-alkylaryl, by the following steps, which can be carried out in any order,

A) reaction with a compound of the formula 2

OHC—COOR² (2)

in which R² has the meaning H, C₁-C₃₀-alkyl, C₂-C₃₀-alkenyl, C₆-C₁₈-aryl or C₇-C₃₀-alkylaryl, and

B) alkoxylation with a C₂-C₄-alkylene oxide in molar excess, so that the resulting alkoxylate has a degree of alkoxylation of from 1 to 100 alkylene oxide units per OH group,

and which have a molecular weight of from 250 to 100 000 units, in amounts of from 0.0001 to 5% by weight, based on the emulsion, as breakers for oil/water emulsions, in particular in petroleum recovery.

The compounds of the formula 1 are essentially chemically uniform compounds which are not used in mixtures with one another. The term “essentially” here means that compounds of the formula (1) in standard commercial purity are used for the preparation of the resins according to the invention. Fractions of further compounds which come under the formula (1) may also be present in the resins; reference may be made, in particular, to fractions of each of the two other aromatic substitutional isomers which have not been completely separated off.

Alternatively to the condensation of the alkylphenols with glyoxylic acid esters, it is possible to also react the alkylphenols initially with glyoxylic acid and then to esterify the resulting resin.

R² is preferably hydrogen. If one of the radicals R¹ or R² is an alkenyl or alkyl radical, then its chain length is preferably 1 to 18, particularly preferably 2 to 14, specifically 4 to 12, carbon atoms. Alkyl and alkenyl radicals can either be linear or branched.

If one of the radicals R¹ or R² is an alkylaryl radical, then alkylaryl is preferably a radical bonded via the aromatic nucleus whose aromatic nucleus preferably comprises 6 carbon atoms, and which, in the ortho, meta or para position relative to the abovementioned bond, carries an alkyl radical having a chain length of preferably 1 to 18, particularly preferably 4 to 16, in particular 6 to 12, carbon atoms.

If step A is firstly carried out followed by step B, then the compounds of the formula 1 are reacted with compounds of the formula 2 to give a resin. The compounds of the formula 2 are preferably those in which R² is H or an alkenyl or alkyl radical having a chain length of preferably 1 to 18, particularly preferably 2 to 14, specifically 4 to 12, carbon atoms.

The condensation can either be carried out with acidic or basic catalysis. The resins obtained from the condensation are then alkoxylated with a C₂-C₄-alkylene oxide, preferably ethylene oxide or propylene oxide. The alkoxylating agent is used in a molar excess. The alkoxylation takes place on the free OH or COOH groups of the resulting resin. The amount of alkylene oxide used is such that the average degree of alkoxylation is between 1 and 100 alkylene oxide units per free OH or COOH group. The average degree of alkoxylation is understood here as meaning the average number of alkoxy units which are positioned on each free OH or COOH group. It is preferably 1 to 70, in particular 2 to 50.

The resin obtained following condensation and alkoxylation preferably has a molecular weight from 500 to 50 000 units, in particular from 1000 to 10 000 units.

Preferred resins which are obtainable by the process described have, for example, the following structure:

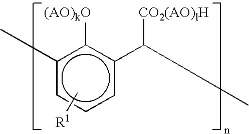

(AO)_{k,l}O is the alkoxylated OH radical in which AO is the alkylene oxide unit, and k, l are the degrees of alkoxylation. The bridging of the aromatic rings via the carbon atom carrying the radical CO₂R² can be located on any of the free positions of the aromatic rings. n is the degree of condensation of the resin. n is preferably a number from 2 to about 100, in particular 3 to 50, particularly preferably 4 to 30, specifically 4 to 10. R¹ is preferably an alkenyl or alkyl radical whose chain length is preferably 1 to 18, particularly preferably 2 to 14, especially 4 to 12, carbon atoms. Alkyl and alkenyl radicals can either be linear or branched.

If R¹ is an alkylaryl radical, then alkylaryl is preferably a radical bonded via an aromatic nucleus whose aromatic nucleus preferably comprises 6 carbon atoms, and which, in the ortho, meta or para position relative to the abovementioned bond, carries an alkyl radical having a chain length of preferably 1 to 18, particularly preferably 4 to 16, in particular 6 to 12, carbon atoms.

For use as petroleum breakers, the resins are added to the water-oil emulsions, which preferably takes place in solution. Preferred solvents are paraffinic or aromatic solvents. The resins are used in amounts of from preferably 0.0005 to 2, in particular 0.0008 to 1 and especially 0.001 to 0.1% by weight, of resin, based on the oil content of the emulsion to be broken.

The resins according to the invention are generally prepared by acid- or alkali-catalyzed condensation of the corresponding alkylphenols with the aldehydes of the formula 2, where the alkoxylation can precede or follow the condensation. The reaction temperature is generally between. 50 and 170° C., preferably 120 to 165° C. The reaction is normally carried out at atmospheric pressure. Examples of catalyzing acids are HCl, H₂SO₄, sulphonic acids or H₃PO₄, and bases which may be mentioned are NaOH, KOH or triethylamine, which are used in amounts of from 0.1 to 50% by weight, based on the weight of the reaction mixture. If glyoxylic acid is used for the condensation, then an addition of acid is not necessary. In this case, the reaction is catalyzed by the glyoxylic acid. The condensation generally requires from 30 min to 6 hours. The molar ratio between aldehyde and aromatic compound is generally from 0.5:1 to 4:1, preferably from 0.8:1 to 1.8:1.

As is known in the prior art, the alkoxylation takes place by reacting the resins with an alkylene oxide under an increased pressure of generally from 1.1 to 20 bar at temperatures of from 50 to 200°C.

### EXAMPLES

### Example 1

### Reaction of P-Isononylphenol with Glyoxylic Acid (Acidic Catalysis)

100.0 g of p-isononylphenol (M=220) and 0.7 g of alkylbenzenesulfonic acid (0.5 mol %) were dissolved in 100 g of an aromatic solvent in a 500 ml stirred flask fitted with contact thermometer, stirrer, dropping funnel and water separator. With stirring and nitrogen blanketing, the reaction mixture was heated to 120° C. At 120° C., 23.8 g of glyoxylic acid solution (50% strength in water) were slowly added dropwise. When the addition was complete, the mixture was after-reacted for one hour at 120° C. and for one hour at 165° C. The water of reaction which formed during the process was withdrawn via the separator. The product was evaporated to dryness on a rotary evaporator (yield: 112.5 g) and analyzed by GPC.

### Example 2

### Reaction of P-Isononylphenol with Glyoxylic Acid (Alkaline Catalysis)

100.0 9 of p-isononylphenol (M=220) and 23.4 g of 40% strength potassium hydroxide solution were introduced and dispersed in 100 g of an aromatic solvent in a 500 ml stirred flask fitted with contact thermometer stirrer, dropping funnel and water separator. Then, with stirring and nitrogen blanketing, the reaction mixture was heated to 120° C. and, at this temperature, 23.8 g of glyoxylic acid solution (50% strength in water) were slowly added dropwise. When the addition was complete, the mixture was after-reacted for one hour at 120° C. and for one hour at 165° C. The water of reaction which formed in the process was withdrawn via the separator. The product was evaporated to dryness on a rotary evaporator (yield: 115.2 g) and analyzed by means of GPC.

### Example 3

### Reaction of P-Isononylphenol with Glyoxylic Acid Dodecyl Ester (Acidic Catalysis)

100.0 g of p-isononylphenol (M=220) and 0.7 g of alkylbenzenesulfonic acid (0.5 mol %) were dissolved in 100 g of an aromatic solvent in a 500 ml stirred flask fitted with contact thermometer, stirrer, dropping funnel and water separator. With stirring and nitrogen blanketing, the reaction mixture was heated to 120° C. At 120° C., 23.8 g of glyoxylic acid solution (50% strength in water) were slowly added dropwise. When the addition was complete, the mixture was after-reacted for one hour at 120° C. and for one hour at 165° C. The water of reaction which formed during the process was withdrawn via the separator. The product was evaporated to dryness on a rotary evaporator (yield: 112.5 g) and analyzed by GPC.

### Example 4

### Reaction of P-Isononylphenol with Glyoxylic Acid and Subsequent Esterification with Dodecanol

100.0 g of p-isononylphenol (M=220) and 0.7 g of alkylbenzenesulfonic acid (0.5 mol %) were dissolved in 100 g of an aromatic solvent in a 500 ml stirred flask fitted with contact thermometer, stirrer, dropping funnel and water separator. With stirring and nitrogen blanketing, the reaction mixture was heated to 120° C. At 120° C., 23.8 g of glyoxylic acid solution (50% strength in water) were slowly added dropwise. When the addition was complete, the mixture was after-reacted for one hour at 120° C. and for one hour at 165° C. The water of reaction which formed in the process was withdrawn via the separator. The reaction mixture was cooled to 120° C., 84.5 g of dodecanol (M=186) in 50 g of an aromatic solvent were slowly added dropwise and the water of reaction which formed was withdrawn via the separator. The product was evaporated to dryness on a rotary evaporator (yield: 179.8 g) and analyzed by means of GPC.

### Example 5

### Reaction of P-Tert-Butylphenol with Glyoxylic Acid (Acidic Catalysis)

100.0 9 of p-tert-butylphenol (M=150) and 1.0 g of alkylbenzenesulfonic acid (0.5 mol %) were dissolved in 100 g of an aromatic solvent in a 500 ml stirred flask fitted with contact thermometer, stirrer, dropping funnel and water separator. With stirring and nitrogen blanketing, the reaction mixture was heated to 120° C. At 120° C., 34.9 g of glyoxylic acid solution (50% strength in water) were slowly added dropwise. When the addition was complete, the mixture was after-reacted for one hour at 120° C. and for one hour at 165° C. The water of reaction which formed during the process was withdrawn via the separator. The product was evaporated to dryness on a rotary evaporator (yield: 116.3 g) and analyzed by GPC.

### Example 6

### Reaction of P-Cumylphenol with Glyoxylic Acid (Acidic Catalysis)

100.0 g of p-cumylphenol (M=212) and 0.7 g of alkylbenzenesulfonic acid (0.5 mol %) were dissolved in 100 g of an aromatic solvent in a 500 ml stirred flask fitted with contact thermometer, stirrer, dropping funnel and water separator. With stirring and nitrogen blanketing, the reaction mixture was heated to 120° C. At 120° C., 24.7 g of glyoxylic acid solution (50% strength in water) were slowly added dropwise. When the addition was complete, the mixture was after-reacted for one hour at 120° C. and for one hour at 165° C. The water of reaction which formed during the process was withdrawn via the separator. The product was evaporated to dryness on a rotary evaporator (yield: 112.8 g) and analyzed by GPC.

### Example 7

### Reaction of Cardanol with Glyoxylic Acid (Acidic Catalysis)

100.0 g of cardanol (m-C₁₅-alkenylphenol, M=302) and 0.5 g of alkyl-benzenesulfonic acid (0.5 mol %) were dissolved in 100 g of an aromatic solvent in a 500 ml stirred flask fitted with contact thermometer, stirrer, dropping funnel and water separator. With stirring and nitrogen blanketing, the reaction mixture was heated to 120° C. At 120° C., 17.3 g of glyoxylic acid solution (50% strength in water) were slowly added dropwise. When the addition was complete, the mixture was after-reacted for one hour at 120° C. and for one hour at 165° C. The water of reaction which formed during the process was withdrawn via the separator. The product was evaporated to dryness on a rotary evaporator (yield: 107.3 g) and analyzed by GPC.

### Example 8

### Reaction of P-Phenylphenol with Glyoxylic Acid (Acidic Catalysis)

100.0 9 of p-phenylphenol (M=170) and 0.9 g of alkylbenzenesulfonic acid (0.5 mol %) were dissolved in 100 g of ah aromatic solvent in a 500 ml stirred flask fitted with contact thermometer, stirrer, dropping funnel and water separator. With stirring and nitrogen blanketing, the reaction mixture was heated to 120° C. At 120° C., 30.8 g of glyoxylic acid solution (50% strength in water) were slowly added dropwise. When the addition was complete, the mixture was after-reacted for one hour at 120° C. and for one hour at 165° C. The water of reaction which formed during the process was withdrawn via the separator. The product was evaporated to dryness on a rotary evaporator (yield: 114.9 g) and analyzed by GPC.

### Example 9

### Reaction of P-Isononylphenol and P-Tert-Butylphenol with Glyoxylic Acid (Acidic Catalysis)

50.0 g of p-isononylphenol (M=220), 50.0 g of p-tert-butylphenol (M=150) and 0.8 g of alkylbenzenesulfonic acid (0.5 mol %) were dissolved in 100 g of an aromatic solvent in a 500 ml stirred flask fitted with contact thermometer, stirrer, dropping funnel and water separator. With stirring and nitrogen blanketing, the reaction mixture was heated to 120° C. At 120° C., 28.3 g of glyoxylic acid solution (50% strength in water) were slowly added dropwise. When the addition was complete, the mixture was after-reacted for one hour at 120° C. and for one hour at 165° C. The water of reaction which formed during the process was withdrawn via the separator. The product was evaporated to dryness on a rotary evaporator (yield: 113.2 g) and analyzed by GPC.

### Oxyalkylation of the Alkylphenol Glyoxylic Acid Derivative Condensates

### Ethylene Oxide

The resins described above were introduced into a 1 l glass autoclave and the pressure in the autoclave was adjusted to about 0.2 bar above atmospheric with nitrogen. The autoclave was heated slowly to 140° C. and, after this temperature had been reached, the pressure was adjusted again to 0.2 bar above atmospheric. Then, at 140° C., the desired amount of EO was metered in, during which the pressure should not exceed 4.5 bar. When the EO addition was complete, the mixture was left to after-react for a further 30 minutes at 140° C.

### Propylene Oxide

The resins described above were introduced into a 1 l glass autoclave and the pressure in the autoclave was adjusted to about 0.2 bar above atmospheric with nitrogen. The autoclave was slowly heated to 130° C. and, after this temperature had been reached, the pressure was again adjusted to 0.2 bar above atmospheric. Then, at 130° C., the desired amount of PO was metered in, during which the pressure should not exceed 4.0 bar. When the PO addition was complete, the mixture was left to after-react for a further 30 minutes at 130° C.

### Determination of the Breaking Effectiveness of Petroleum Demulsifiers

To determine the effectiveness of a demulsifier, the water separation from a crude oil emulsion per time, and also the dewatering and desalting of the oil were determined. For this, demulsifying glasses (tapered, graduated glass bottles with screw lids) were charged in each case with 100 ml of the crude oil emulsion, in each case a defined amount of the demulsifier was metered in just below the surface of the oil emulsion using a micropipette, and the breaker was mixed into the emulsion by intensive shaking. The demulsifying glasses were then placed in a conditioning bath (30° C. and 50° C.) And water separation was monitored.

During demulsification and after it had finished, samples were taken from the oil from the upper section of the demulsifying glass (so-called top oil), and the water content was determined in accordance with Karl Fischer and the salt content was determined conductometrically. In this way, it was possible to assess the novel breakers according to water separation and also dewatering and desalting of the oil.

### Breaking Action of the Breakers Described

| | |
|---|---|
| Origin of the crude oil emulsion: | Holzkirchen sonde 3, Germany |
| Water content of the emulsion: | 46% |
| Salt content of the emulsion: | 5% |
| Demulsification temperature: | 50° C. |

| | | | | | | | | | | | Water | Salt in |
|---|---|---|---|---|---|---|---|---|---|---|---|---|
| Water | | | | | | | | | | | in the | the top |
| separation [ml] | Concentration | | | | | | | | | | top oil | oil |
| per time [min] | [ppm] | 5 | 10 | 20 | 30 | 45 | 60 | 90 | 120 | 180 | [%] | [%] |
| Product from 1 + | 50 | 1 | 8 | 20 | 34 | 42 | 46 | 46 | 46 | 46 | 0.45 | 80 |
| 3.2 mol of EO | | | | | | | | | | | | |
| Product from 2 + | 50 | 5 | 15 | 24 | 40 | 45 | 46 | 46 | 46 | 46 | 0.19 | 37 |
| 4.0 mol of EO | | | | | | | | | | | | |
| Product from 3 + | 50 | 7 | 20 | 31 | 42 | 46 | 46 | 46 | 46 | 46 | 0.28 | 42 |
| 3.6 mol of EO | | | | | | | | | | | | |
| Product from 4 + | 50 | 7 | 21 | 32 | 42 | 46 | 46 | 46 | 46 | 46 | 0.29 | 40 |
| 2.8 mol of EO | | | | | | | | | | | | |
| Product from 5 + | 50 | 5 | 17 | 28 | 37 | 42 | 45 | 45 | 46 | 46 | 0.43 | 78 |
| 5.6 mol of EO | | | | | | | | | | | | |
| Product from 6 + | 50 | 4 | 16 | 29 | 37 | 43 | 44 | 44 | 46 | 46 | 0.38 | 67 |
| 3.3 mol of EO | | | | | | | | | | | | |
| Product from 7 + | 50 | 2 | 8 | 16 | 25 | 35 | 43 | 44 | 45 | 45 | 0.92 | 112 |
| 20.4 mol of PO | | | | | | | | | | | | |
| Product from 8 + | 50 | 1 | 7 | 15 | 20 | 30 | 40 | 43 | 44 | 46 | 0.78 | 83 |
| 30.2 mol of PO | | | | | | | | | | | | |
| Product from 9 + | 50 | 2 | 9 | 21 | 32 | 39 | 44 | 46 | 46 | 46 | 0.45 | 51 |
| 30.0 mol of PO | | | | | | | | | | | | |
| Standard: | 100 | 0 | 4 | 10 | 17 | 26 | 34 | 39 | 42 | 43 | 1.58 | 198 |
| Dissolvan 1952 | | | | | | | | | | | | |

1. The use of resins obtainable from compounds of the formula (1) 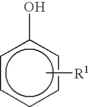
in which the substituents R¹ and OH may be in ortho, meta or para position relative to one another, and R¹ is C₁-C₃₀-alkyl, C₂-C₃₀-alkenyl, C₆-C₁₈-aryl or C₇-C₃₀-alkylaryl, by the following steps, which can be carried out in any order,
A) reaction with a compound of the formula 2
OHC—COOR² (2)
in which R² has the meaning H, C₁-C₃₀-alkyl, C₂-C₃₀-alkenyl, C₆-C₁₈-aryl or C₇-C₃₀-alkylaryl, and
B) alkoxylation with a C₂-C₄-alkylene oxide in molar excess, so that the resulting alkoxylate has a degree of alkoxylation of from 1 to 100 alkylene oxide units per OH group,
and which have a molecular weight of from 250 to 100 000 units, in amounts of from 0.0001 to 5% by weight, based on the emulsion, as breakers for oil/water emulsions, in particular in petroleum recovery:

2. The use as claimed in claim 1, in which R¹ is an alkyl or alkenyl radical having 4 to 12 carbon atoms.

3. The use as claimed in claim 1 and/or 2, in which R² is hydrogen.

4. The use as claimed in one or more of claims 1 to 3, in which the degree of alkoxylation is between 2 and 50.

5. The use as claimed in one or more of claims 1 to 4, in which the molecular weight is between 1000 and 10 000.

6. A compound of the formula 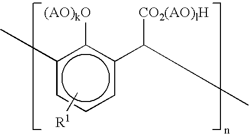
in which R¹ is C₁-C₃₀-alkyl, C₂-C₃₀-alkenyl, C₆-C₁₈-aryl or C₇-C₃₀-alkyl-aryl, AO is C₂- to C₄-alkylene oxide, n is a number between 2 and 100 and k and l, independently of one another, are a number between 1 and 100, with the proviso that k+l is at most 100.

7. A compound as claimed in claim 6, in which k and l are numbers between 2 and 50.

8. A compound as claimed in claim 6 and/or 7, in which R¹ is an alkenyl or alkyl radical whose chain length is 4 to 12 carbon atoms.

9. A compound as claimed in one or more of claims 6 to 8, in which n is 4to 10.
